(19) United States
(12) Patent Application Publication
(10) Pub. No.: US 2026/0229747 A1
(43) Pub. Date: Aug. 6, 2026

(54) BATTERY PACK

(71) Applicant: BOMBARDIER RECREATIONAL PRODUCTS INC., Valcourt (CA)

(72) Inventor: Denis BOURASSA, Valcourt (CA)

(21) Appl. No.: 19/465,166

(22) Filed: Jan. 30, 2026

Related U.S. Application Data
(60) Provisional application No. 63/752,218, filed on Jan. 31, 2025.

(51) Int. Cl. H01M 50/588; B60L 50/64; B62J 43/16; H01M 10/42; H01M 50/213; H01M 50/249; H01M 50/262; H01M 50/271; H01M 50/507

(52) U.S. Cl. CPC H01M 50/588; H01M 10/425; H01M 50/213; H01M 50/249; H01M 50/262; H01M 50/271; H01M 50/507; B60L 50/64; B62J 43/16; H01M 2220/20

(57) ABSTRACT

A battery pack includes at least two low-voltage units, a first conductor and a retention assembly. The first conductor is selectively electrically connected to the at least two low-voltage units such that a voltage between two conductors of the battery pack is greater than a pre-determined voltage. The retention assembly is configured to, with the first conductor electrically connected to the at least two low-voltage units, prevent disconnection of the at least two low-voltage units from each other. In response to the first conductor being electrically disconnected from the at least two low-voltage units, the retention assembly stops the first conductor from being electrically connected to the at least two low-voltage units.

### CROSS-REFERENCE TO RELATED APPLICATIONS

The present application claims priority to U.S. Provisional Patent Application No. 63/752,218, filed Jan. 31, 2025, entitled “Battery Pack”, which is incorporated by reference herein in its entirety.

### FIELD OF TECHNOLOGY

The present technology relates to battery pack configurations.

### BACKGROUND

The increasing popularity of electric vehicles has led to a greater demand for the repair and servicing of their various components, including battery packs.

Traditional battery packs can be prone to damage during their assembly and/or during their servicing. These battery packs include numerous electronic components, such as cells, that are vulnerable to high-voltage exposure. The cells may get damaged if subjected to a short circuit. The damage may cause the cells to overheat and to trigger internal protective devices. If a conductive tool or a conductive component, such as a dropped conductive fastener, contacts a high-voltage circuit, it can cause accidental arcing or short circuits, potentially leading to immediate and/or latent damage to the cells or to the other electronic components. Such latent damage may not be immediately detectable and may only become apparent after the battery pack has been reassembled and deemed operational.

Additionally, the process for assembling and disassembling traditional battery packs can have a lot of steps that can be time-consuming to perform, and if done incorrectly, can cause damage to components of the battery packs.

Accordingly, there exists a need for an improved battery pack design that mitigates the aforementioned deficiencies.

### SUMMARY

According to an aspect of the present technology, there is provided a battery pack. The battery pack includes at least two low-voltage units, a first conductor and a retention assembly. The first conductor is selectively electrically connected to the at least two low-voltage units such that a voltage between two conductors of the battery pack is greater than a pre-determined voltage. The retention assembly is configured to, with the first conductor electrically connected to the at least two low-voltage units, prevent disconnection of the at least two low-voltage units from each other. In response to the first conductor being electrically disconnected from the at least two low-voltage units, stop the first conductor from being electrically connected to the at least two low-voltage units.

In some embodiments, the retention assembly includes a stopping assembly including a stopper, a biasing member, a locking member and an unlocking member. The stopper is disposed on a first component of the battery pack and is moveable between a retracted position and an extended position. The biasing member biases the stopper toward the extended position. The locking member is disposed on the first component and is moveable between a locked position, in which the locking member is engaged with the stopper, and an unlocked position, in which the locking member is disengaged from the stopper. The unlocking member is disposed on a second component of the battery pack, and is different from the first component, the second component being adjacent to the first component. The first component is connected to the second component, and the first conductor is electrically connected to the at least two low-voltage units such that the unlocking member causes the locking member to be in the unlocked position, thereby permitting the stopper to be selectively moved between the retracted position and the extended position, and the first conductor places the stopper in the retracted position. In response to the first component being disconnected from the second component and the first conductor being electrically disconnected from the at least two low-voltage units, the stopper is configured to move to the extended position, and the locking member is configured to move to the locked position, thereby preventing the stopper from moving toward the retracted position, such that the stopper stops the first conductor from being electrically connected to the at least two low-voltage units.

In some embodiments, the first component is one of the at least two low-voltage units, and the second component is an other one of the at least two low-voltage units.

In some embodiments, the battery pack further includes a connection unit comprising a connection interface and a connection holder. The first component is one of the connection interface and the connection holder, and the second component is one of an other one of the connection interface and the connection holder.

In some embodiments, the battery pack further includes a first cover made of non-conductive material connected to the first connector.

In some embodiments, the battery pack includes at least one exposed conductor, and with the first conductor electrically connected to the at least two low-voltage units, the cover covers the at least one exposed conductor.

In some embodiments, the retention assembly includes first and second interlockers. The first interlocker is disposed on a third component of the battery pack, and the second interlocker is disposed on the cover. With the first conductor electrically connected to the at least two low-voltage units, the third component is connected to one of the at least two low-voltage units, and the second interlocker is interlocked with the first interlocker, thereby preventing disconnection of the third component from the one of the at least two low-voltage units. In response to the first conductor being removed from the at least two low-voltage units, the first interlocker is disengaged from the second interlocker such that the third component is disconnectable from the one of the at least two low-voltage units.

In some embodiments, the battery pack further includes a connection unit, and the third component is one of the connection unit and an other one of the at least two low-voltage units.

In some embodiments, the at least two low-voltage units are at least two battery modules.

In some embodiments, the first conductor is at least one busbar.

According to another aspect of the present technology, there is provided a battery pack. The battery pack includes at least two battery modules, a connection unit, a plurality of conductors, at least one busbar, and a stopping assembly. Each battery module of the at least two battery modules includes at least two cells being electrically connected to one another to form a low-voltage circuit. The connection unit is selectively electrically connected to at least one of the at least two battery modules and has a connection interface. The plurality of conductors is disposed on at least one of the at least two battery modules and the connection unit. The at least one busbar is selectively electrically connected to the at least two battery modules to form a high-voltage circuit between two conductors of the plurality of conductors. The stopping assembly includes a stopper, a biasing member, and a locking member. The stopper is disposed on a first component of the battery pack, the first component of the battery pack being one of the connection unit, or one of the at least two battery modules. The stopper is moveable between a retracted position and an extended position. The biasing member biases the stopper toward the extended position. The locking member is disposed on the first component and is moveable between a locked position, in which the locking member is engaged with the stopper, and an unlocked position, in which the locking member is disengaged from the stopper. The unlocking member is disposed on a second component of the battery pack, the second component of the battery pack being one of the connection unit, the one of the at least two battery modules, and another one of the at least two battery modules. The second component is different from the first component. The second component is adjacent to the first component. The first component is connected to the second component and the at least one busbar is electrically connected to the at least two battery modules such that the unlocking member causes the locking member to be in the unlocked position permitting the stopper to be selectively moved between the retracted position and the extended position, and the at least one busbar places the stopper in the retracted position. In response to the first component being disconnected from the second component and the at least one busbar being electrically disconnected from the at least two battery modules, the stopper is configured to move to the extended position. The locking member is configured to move to the locked position, thereby preventing the stopper from moving toward the retracted position such that the stopper stops the at least one busbar from being electrically connected to the at least two battery modules.

In some embodiments, the second component is the connection unit, and the first component is one of the at least two battery modules.

In some embodiments, the battery pack further comprises at least one busbar assembly, the at least one busbar assembly includes the at least one busbar, and a cover covering the at least one busbar.

In some embodiments, the cover is made of an electrically non-conducting material.

In some embodiments, the at least one busbar is a plurality of busbars electrically connecting the at least two battery modules in series.

In some embodiments, the at least two battery modules include seven battery modules, and the at least one busbar includes eight busbars.

In some embodiments, the high-voltage circuit has a voltage greater than 60 volts.

In some embodiments, the stopper has a protrusion, and the locking member defines an aperture sized to receive the protrusion. With the locking member in the locked position, the protrusion is received in the aperture, and with the locking member in the unlocked position, the protrusion is out of the aperture.

In some embodiments, the connection unit further comprises at least one of a charger, an inverter, or a DC-DC converter, and the at least one of the charger, the inverter, or the DC-DC converter is part of the high-voltage circuit.

In some embodiments, the at least two cells of the at least one of the at least two battery modules are connected in parallel.

In some embodiments, the at least two battery modules and the connection unit are mechanically connected to one another.

According to another aspect of the present technology, there is provided a battery pack. The battery pack includes at least two battery modules, a connection unit, and at least one busbar assembly. Each battery module of the at least two battery modules includes at least two cells that are electrically connected to one another to form a low-voltage circuit. The connection unit is selectively connected to at least one of the at least two battery modules. The connection unit has a connection interface and has a first interlocker. The at least one busbar assembly includes at least one busbar and a cover. The at least one busbar is selectively electrically connected to the at least two battery modules to form a high-voltage circuit. The cover covers the at least one busbar, and has a second interlocker selectively interlocked with the first interlocker. The at least one busbar is electrically connected to the at least two battery modules such that the second interlocker is interlocked with the first interlocker thereby preventing disconnection of the connection unit from the at least two battery modules. In response to the at least one busbar assembly being removed from the connection unit and the at least two battery modules, the first interlocker being disengaged from the second interlocker such that the connection unit is disconnectable from the at least two battery modules.

In some embodiments, the at least one busbar is connected to the cover such that in response to the at least one busbar assembly being removed from the connection unit and the at least two battery modules, the at least one busbar assembly is configured to remove the at least one busbar together with the cover.

In some embodiments, the first interlocker is a recess, and the second interlocker is a protrusion configured to be received in the recess.

In some embodiments, the cover is made of an electrically non-conducting material.

In some embodiments, the high-voltage circuit has a voltage greater than 60 volts.

According to another aspect of the present technology, there is provided a method for disassembling a battery pack. The battery pack has at least two battery modules, at least one busbar and a connection unit. The at least one busbar selectively electrically connects the at least two battery modules to form a high-voltage circuit. The connection unit is selectively electrically connected to the at least two battery modules and selectively mechanically connected to one of the at least two battery modules. The method includes unfastening the at least one busbar from the at least two battery modules, and after unfastening the at least one busbar, moving a busbar cover away from the at least two battery modules and the connection unit, the at least one busbar being connected to and being movable with the busbar cover. In response to moving the cover away from the at least two battery modules and the connection unit, the at least one busbar is electrically disconnected from the at least two battery modules; and a first interlocker disposed on the busbar cover is disengaged from a second interlocker disposed on the connection unit, thereby permitting removal of the connection unit from the one of the at least two battery modules to which it is mechanically connected. After removing the busbar cover, mechanically disconnecting the connection unit from the one of the at least two battery modules to which it is mechanically connected, and mechanically disconnecting each of the at least two battery modules from each other of the at least two battery modules.

According to another aspect of the present technology, there is provided a method for assembling a battery pack. The battery pack includes a first component, a second component, and at least one busbar. The first component is one of a connection unit, and one of at least two battery modules. The second component is one of the connection unit, the one of the at least two battery modules, and another one of the at least two battery modules. The second component is different from the first component. The method includes moving a locking member from a locked position to an unlocked position with an unlocking member by connecting the first component to the second component, the locking member being disposed on the first component, the unlocking member being disposed on the second component. In response to the locking member moving from the locked position to the unlocked position, a stopper disposed on the first component being released from the locking member and becoming movable between an extended position and a retracted position. The method also includes, after connecting the first component to the second component, connecting the at least one busbar to the at least two battery modules to form a high-voltage circuit, connecting the at least one busbar to the at least two battery modules moving the stopper from the extended position to the retracted position. The locking member in the locked position engages the stopper in the extended position and prevents the stopper from moving to the retracted position, thereby preventing connection of the at least one busbar to the at least two batteries due to the stopper interfering with the connection.

Within the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

Additional and/or alternative features, aspects and advantages of embodiments of the present technology will become apparent from the following description and the accompanying drawings.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a top, front, left side of a battery pack according to an embodiment of the present technology;

FIG. 2A is a perspective view taken from a top, front, left side of the battery pack of FIG. 1, with an upper cover of the battery pack being omitted;

FIG. 2B is a perspective view taken from a top, front, left side of the battery pack of FIG. 2A, with a connection interface of the battery pack further being omitted;

FIG. 3 is a partially exploded perspective view taken from a top, front, left side of the battery pack of FIG. 2A;

FIG. 4 is a partially exploded perspective view taken from a top, front, right side of the battery pack of FIG. 2A;

FIG. 5A is a perspective view of a right busbar assembly of the battery pack of FIG. 4;

FIG. 5B is a partially exploded perspective view of the right busbar assembly of FIG. 5A;

FIG. 6A is a partially exploded perspective view of the battery pack of FIG. 2A, with a bottom cover thereof also being omitted;

FIG. 6B is a partially exploded perspective view of a pair of battery modules of the battery pack of FIG. 2A;

FIG. 7 is a partially exploded perspective view taken from a bottom, rear, right side of a connection unit of the battery pack of FIG. 6A;

FIG. 8A is a rear elevation view of an upper right portion of the connection unit of FIG. 7, with a stopper of the connection unit being in an extended position and a locking member of the connection unit being in a locked position;

FIG. 8B is a rear elevation view of the upper right portion of the connection unit of FIG. 7, with the stopper being in the extended position and the locking member being in an unlocked position;

FIG. 9 is a partially exploded perspective view taken from a bottom, rear, right side of the upper right portion of the connection unit of FIG. 7, with the stopper being in a retracted position;

FIG. 10 is a partially exploded perspective view taken from a bottom, rear, left side of the upper right portion of the connection unit of FIG. 7; and

FIG. 11 is a partially exploded perspective view taken from a top, front, left side of a battery pack according to an alternative embodiment of the present technology, with an upper cover being omitted.

It should be noted that, unless otherwise explicitly specified herein, the drawings are not necessarily to scale.

### DETAILED DESCRIPTION

The present technology will be described herein with respect to a battery pack 100 for powering an electric vehicle and, in particular, powersport vehicles. The battery pack 100 may be incorporated in a variety of electric vehicle types including, but not limited to, electric motorcycles, electric snowmobiles, electric all-terrain vehicles, two-wheeled straddle-seat electric vehicles, three-wheeled electric vehicles, electric side-by-side vehicles, four-wheeled electric vehicles, electric watercraft, etc. It is contemplated that at least some aspects of the present technology may also be used in electric vehicles other than electric powersport vehicles. It is further contemplated that the battery pack 100 may be used for powering devices other than electric vehicles.

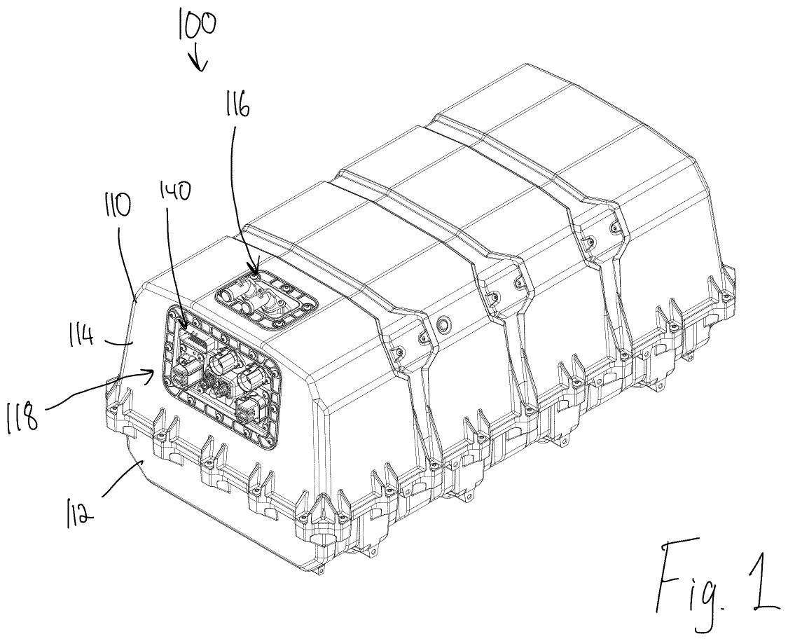

FIG. 1 depicts a top-side perspective external view of the battery pack 100 in accordance with a non-limiting embodiment of the present technology. The battery pack 100 includes a battery housing 110 for enclosing various components of the battery pack 100. In the illustrated embodiment, the battery housing 110 has a generally rectangular cuboid form, though it is contemplated that the battery housing 110 could be shaped differently depending on various factors, such as the available space and configuration of the electric vehicle.

The battery housing 110 includes a bottom cover 112 and an upper cover 114. The bottom and upper covers 112, 114 are selectively fastened to one another. It is contemplated that the battery housing 110 could include three or more covers. It is also contemplated that the bottom and upper covers 112, 114 could be connected together in a variety of different ways that allow for the selective attachment/detachment of the covers 112, 114, such as, for example, tabs, latches, spring fasteners, etc. It is contemplated that the material used for the top and bottom covers 112, 114 may include carbon-based materials, metal(s), metallic and/or carbon particle-infused composite(s), paramagnetic material(s), and may further incorporate a metallic screen, metallic wires, metallic tape, metallic sheets, metallic coating, etc.

The upper cover 114 defines a top aperture 116 and a front aperture 118. The top and front apertures 116, 118 are configured to receive components of the battery pack 100 therethrough.

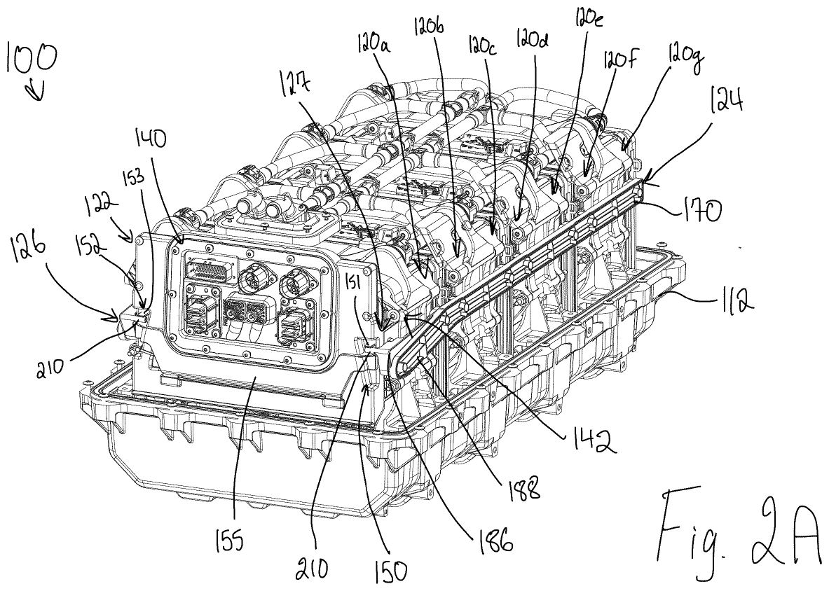

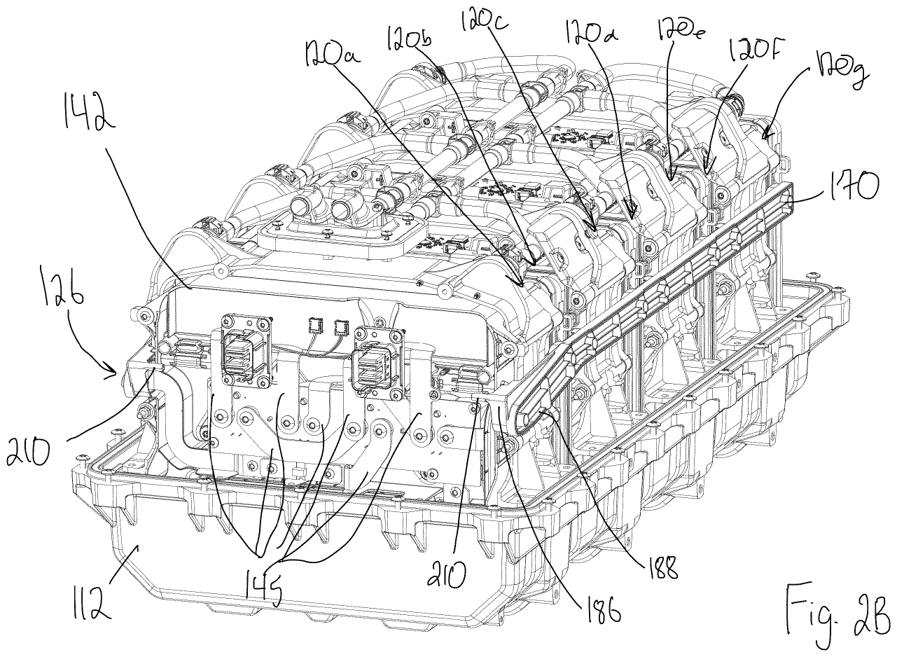

Referring to FIGS. 2A, 2B, 3 and 4, the battery pack 100 also includes battery modules 120a, 120b, 120c, 120d, 120e, 120f, 120g (collectively referred to as battery modules 120), a connection unit 122, a left conductor assembly 124, a right conductor assembly 126, and a retention assembly 127, which includes a left stopping assembly 128 and a right stopping assembly 129. As will be described below, the retention assembly 127 is configured to, in certain conditions, prevent connection of the battery modules 120 and either of the conductor assemblies 124, 126 to one another and prevent disconnection of the battery modules 120 and the connection unit 122 from one another.

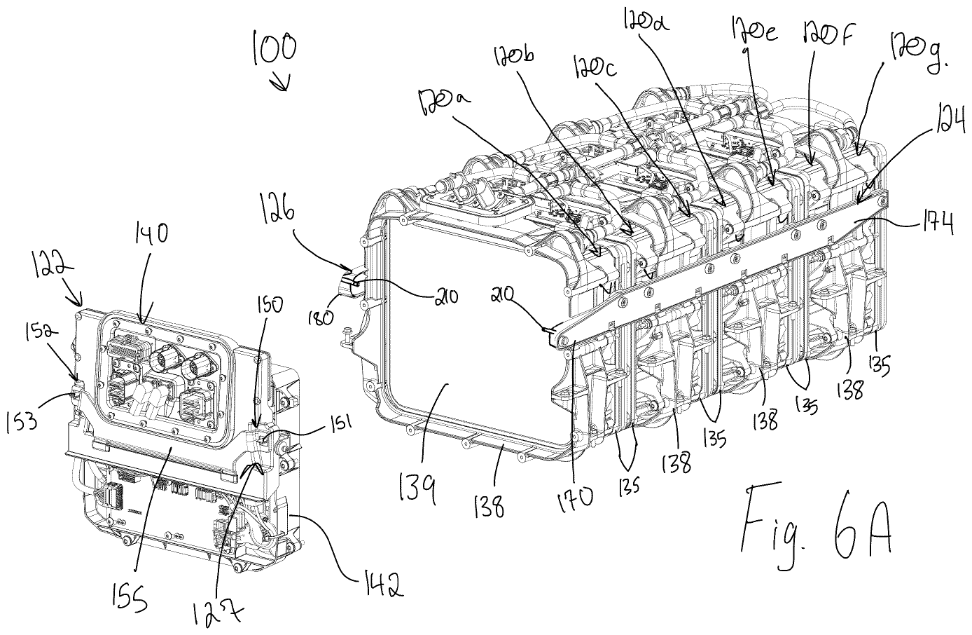

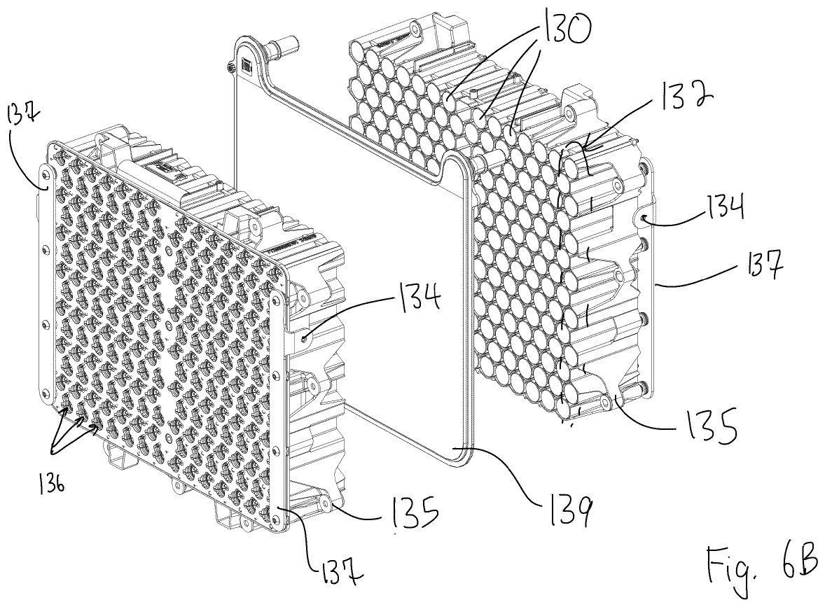

In the present embodiment, the battery pack 100 includes seven battery modules 120. It is contemplated that in other embodiments, the battery pack 100 may include two, three, four, five, six, eight or more battery modules 120. Referring to FIG. 6B, each battery module 120 includes cells 130, a holding matrix 135 holding the cells 130, and two terminals 134.

The cells 130 are lithium-ion cells 130, though it is contemplated that other types of cells may be used. The cells 130 are grouped together to form cell groups 132 (only one cell group 132 identified in FIG. 6B). Individual cells 130 within the cell groups 132 are connected in parallel between each other. Thus, a single cell group 132, when balanced, has a voltage equivalent to any one of the individual cells 130 within it. The cell groups 132 are connected in series to one another, within the battery module 120, to form a module circuit. The module circuit has the two terminals 134 electrically connected thereto. In the present embodiment, the module circuit has a voltage between the terminals 134 that corresponds to the sum of the voltage of each of the cell groups 132 within it. The number of cell groups 132 connected in series is selected so that the voltage is below a pre-determined voltage, regardless of the charge level of the cells 130 within it. Cell voltage is dependent on charge level, with maximal voltage being provided when the cell is fully charged, and decreasing with the charge level of the cells 130. For the purposes of the present description, it is assumed that the cells 130 are fully charged.

Thus, being that the voltage of the battery modules 120 is below the pre-determined voltage, the module circuit has a low voltage and by extension the battery modules 120 are low-voltage units. It is contemplated that the cells 130 could be connected differently which could result in a different module circuit voltage. For the purposes of the present description, the pre-determined voltage is 60V. More specifically, the module circuit formed by the connection of cell groups 132 has a voltage of about 58.8V, and may therefore be referred to as a low-voltage circuit (i.e., each battery module unit 120 has a voltage of about 58.8V). It is contemplated that the pre-determined voltage could be 70V or 50V. Unless otherwise specified, all voltages mentioned herein refer to DC (direct current) supply. It is contemplated that in other embodiments, the pre-determined voltage could be 30V (or other voltage) with alternating current (AC) supply. It is also contemplated that some battery modules 120 may be different from one another. For example, the battery module 120a may have a total voltage of about 58.8V, and the battery module 120b may have a total voltage of about 40V.

Still referring to FIG. 6B, the holding matrix 135 holds the cells 130. In the illustrated embodiment, the holding matrix 135 defines openings 136 in which the cells 130 are received. The holding matrix 135 is sized to fit within the bottom and upper covers 112, 114. The holding matrix 135 is connected to a housing 138. More specifically, the holding matrix 135 is selectively fastened to the housing 138. It is contemplated that the holding matrix 135 and the housings 138 could be connected together in a variety of different ways that allow for the selective attachment/detachment of the holding matrix 135 and the housing 138, such as, for example, tabs, latches, spring fasteners, etc. The housing 138 will be described in greater detail below.

Each battery module 120 also has the two terminals 134. The terminals 134 are electrically connected to the cells 130. One of the terminals 134 is disposed on a left side of the holding matrix 135, and the other terminal 134 is disposed on a right side of the holding matrix 135. It is contemplated that the terminals 134 could be positioned differently. For example, the terminals 134 could be disposed on the same lateral side, and be vertically offset from one another. The terminals 134 of the battery modules 120 are also referred to as interconnection terminals. Each terminal 134 has a conductor bar 137 that substantially extends along a height of the holding matrix 135.

In the illustrated embodiment, the battery pack 100 has four housings 138 (see FIG. 6A). It is contemplated that the number of housings 138 may vary from one embodiment to another. The frontmost housing 138 is connected to the connection unit 122 and to the battery module 120a. Each of the other three housings 138 is connected to two battery modules 120. Each housing 138 includes a cold plate 139 disposed at the middle thereof. Thus, the cold plate 139 of the frontmost housing 138 is disposed between the connection unit 122 and the battery module 120a, whereas the cold plate 139 of the other three housings 138 is disposed between the corresponding two battery modules 120. In the present embodiment, the cold plate 139 is in engagement with the cells 130.

Referring back to FIGS. 2A, 2B, 3 and 4, the connection unit 122 is disposed at an end of the battery pack 100. More specifically, with reference to FIG. 6A, the connection unit 122 is disposed at a front end of the battery pack 100 such that the connection unit 122 is adjacent to the battery module 120a. It is contemplated that the connection unit 122 may be disposed elsewhere. For example, the connection unit 122 may be disposed at a rear end of the battery pack 100, adjacent to the battery module 120g.

The connection unit 122 has a connection interface 140 and a connection holder 142. The connection interface 140 is connected to and supported by the connection holder 142. The connection interface 140 is provided with connection ports to connect to a variety of components of the electric vehicle including, but not limited to, a charger, a power inverter, and a DC-DC converter. When the battery pack 100 is assembled, the connection interface 140 extends through the front aperture 118 of the upper cover 114. The connection holder 142 is shaped similarly to the holding matrix 135 and is connected to the frontmost housing 138. Additionally, the connection holder 142 supports a plurality of conductors 145 (seen in FIG. 2B).

The connection unit 122 also has a left interlocker 150 and a right interlocker 152. In the present embodiment, the left and right interlockers 150, 152 are left and right recesses 150, 152, respectively, and will henceforth be referred to as such. A tab 151 extends longitudinally within the recess 150, and a tab 153 extends longitudinally within the recess 152. The tabs 151, 153 are connected to one another by an intermediate portion 155 extending generally laterally. The tabs 151, 153 and the intermediate portion 155 are monolithic. It is contemplated that the tabs 151, 153 could be separate members. It is contemplated that in some embodiments, the tabs 151, 153 could be omitted. As will be described below, the left and right recesses 150, 152 and the left and right tabs 151, 153 are part of the retention assembly 127, and are configured to engage with the left and right conductor assemblies 124, 126 to prevent disconnection of the connection unit 122 from the battery modules 120.

The connection unit 122 also has two terminals 154 that are electrically connected to the connection interface 140, and that may be referred to as output terminals 154. One of the terminals 154 is disposed on a left side of the connection holder 142, and the other terminal 154 is disposed on a right side of the connection holder 142. When the battery pack 100 is assembled, the terminals 154 of the connection unit 122 are vertically lower than the terminals 134 of the battery modules 120. It is contemplated that the relative positioning between the terminals 134 and the output terminals 154 may vary from one embodiment to another. For example, the terminals 154 may be vertically higher than or vertically aligned with the terminals 134. It is contemplated that in some embodiments, the connection unit 122 could be omitted.

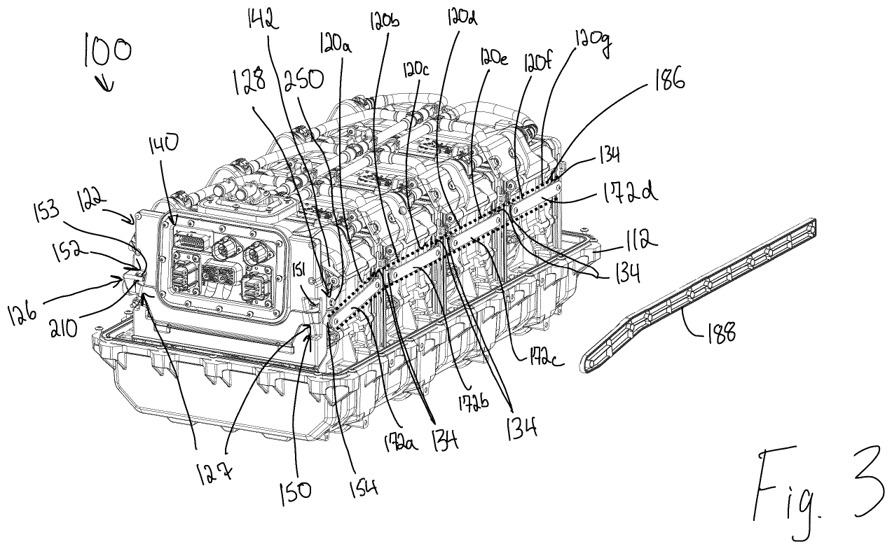

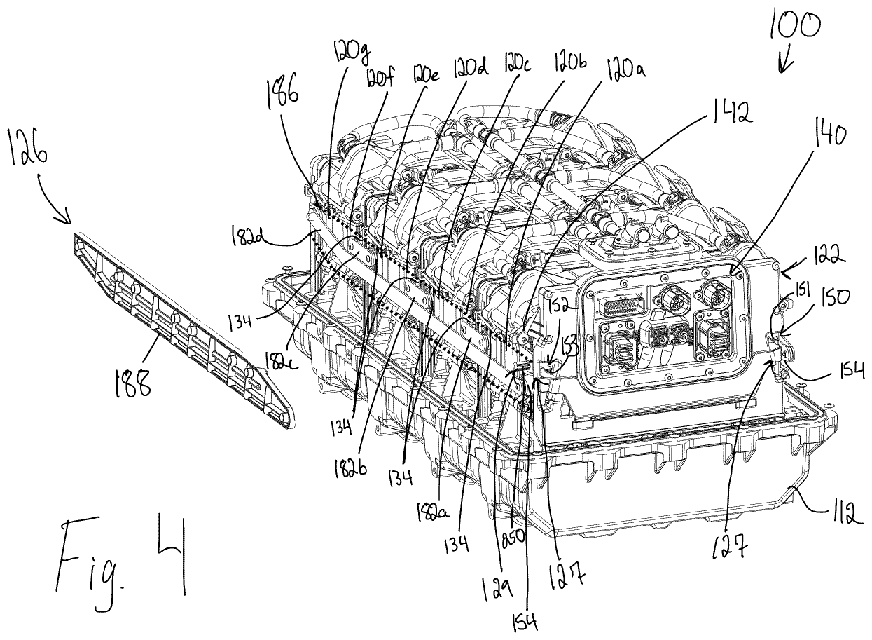

Referring to FIGS. 2A, 2B, 3, 4, 5A and 5B, the left and right conductor assemblies 124, 126 will now be described in greater detail. The left conductor assembly 124, which is disposed on the left side of the battery pack 100, includes a cover 170 (part of which is shown in dotted lines in FIG. 3) and conductors 172a, 172b, 172c, 172d (collectively referred to as conductors 172). As will be described below, the conductors 172 are received in the cover 170. Likewise, the right conductor assembly 126, which is disposed on the right side of the battery pack 100, includes a cover 180 (also part of which is shown in dotted lines in FIG. 4) and conductors 182a, 182b, 182c, 182d (collectively referred to as busbars 182). The conductors 182 are received in the cover 180. The conductors 172, 182 are busbars 172, 182, such that the left and right conductor assemblies 124, 126 are busbar assemblies 124, 126. It is contemplated that in other embodiments, the number of busbars 172, 182 may vary.

As will be described below, the busbar assemblies 124, 126 are selectively connected to the battery modules 120 such that the connected battery modules 120 are connected in series, forming a battery pack circuit. As with the module circuit, the voltage of the battery pack circuit corresponds to the sum of the voltage of the module circuits which are connected in series within it. Thus, the voltage between the output terminals 154 of the battery pack circuit is greater than the predetermined voltage. In the present embodiment, the voltage of the connected battery modules 120 forming the battery pack circuit is about 411.6V between the output terminals 154. It can be said that when the battery modules 120 are connected to one another via the busbar assemblies 124, 126, a high voltage is present between the output terminals 154 of the battery pack 100, as well as between certain pairs of interconnection terminals 134.

The busbars 172a, 172b, 172c, 172d are generally thin plates that are shaped similarly to one another, with the exception that the busbar 172a is longer than the busbars 172b, 172c, 172d. The busbars 172b, 172c, 172d are sized to extend from one terminal 134 of one of the battery modules 120 to another terminal 134 of an adjacent battery module 120, whereas the busbar 172a is sized to extend between the terminal 134 of the connection unit 122 and the terminal 154 of the battery module 120a. Thus, the additional length of the busbar 172a is to accommodate the vertical offset between the terminal 134 of the connection unit 122 and the terminal 154 of the battery module 120a.

The busbars 182a, 182b and 182c are also generally thin plates that are shaped similarly to one another. The busbars 182a, 182b, 182c are sized to extend from one terminal 134 of one of the battery modules 120 to another terminal 134 of an adjacent battery module 120. The busbar 182d is also a thin plate, but is longer than the busbars 182a, 182b, 182c. The busbar 182d is sized to extend from the front end of the battery pack 100 to a rear end of the battery pack 100. More specifically, the busbar 182d is sized and shaped to extend from the terminal 154 of the connection unit 122 to the terminal 134 of the battery module 120g. The busbar 182d is angled to accommodate for the vertical offset between the terminals 134, 154.

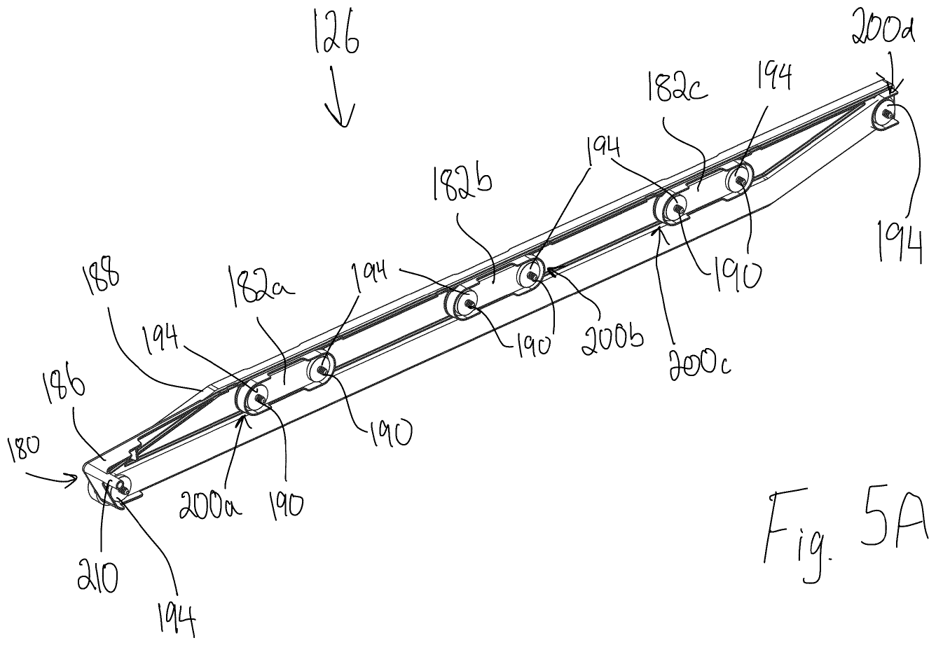

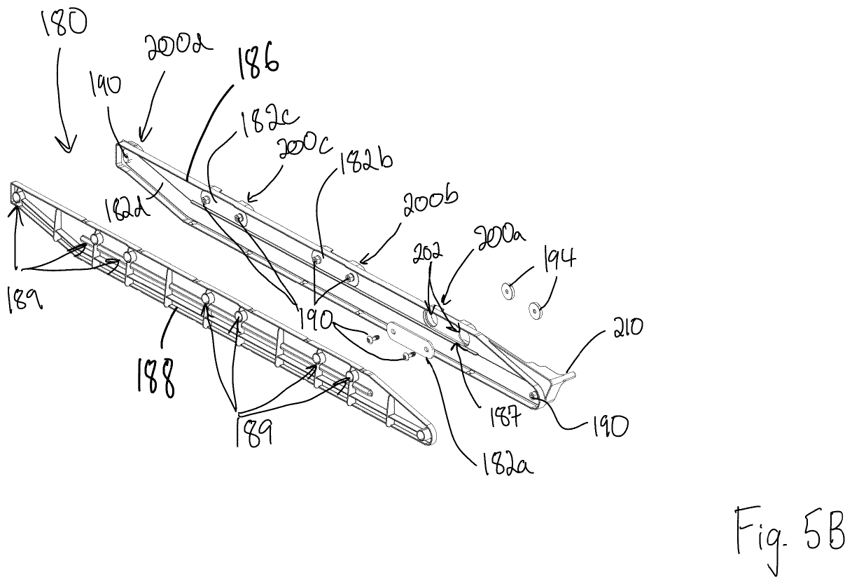

As the busbars 172, 182, are generally similar, only the busbar 182a will be described in detail herewith with reference to FIGS. 5A and 5B, in which features of the busbars 182b, 182c, 182d similar to features of the busbar 182a have been labeled with the same reference numerals.

The busbar 182a defines a front aperture at a front end thereof, and a rear aperture at a rear end thereof. Fasteners 190 are received in the front and rear apertures. The fasteners 190 mechanically fasten the busbar 182 to respective terminals 134. Additionally, metal rings 194 are also connected to the fasteners 190. As will be described in greater detail below, the metal rings 194 accommodate for part of the thickness of the cover 180. It is contemplated that in some embodiments, the metal rings 194 may be omitted.

Still referring to FIGS. 2A, 2B, 3, 4 5A and 5B, the covers 170, 180 will now be described in greater detail. The cover 170 is shaped to connect with and fully cover the busbars 172, whereas the cover 180 is shaped to connect with and fully cover the busbars 182. As the busbars 172 vary in shape from the busbars 182, the cover 170 is shaped differently from the cover 180. Aside from their shapes, the covers 170, 180 are generally similar to one another. Thus, only the cover 180 will be described herewith. Features of the cover 170 similar to features of the cover 180 have been labeled with the same reference numerals.

Referring to FIGS. 5A and 5B, the cover 180 is elongated to reach from the front end of the battery pack 100 to the rear end of the battery pack 100. The cover 180 is made of an inner cover portion 186 and an outer cover portion 188. It is contemplated that the cover 180 could be made of more or fewer portions. The inner cover portion 186 and the outer cover portion 188 are selectively connected to one another. More specifically, in the present embodiment, the inner and outer cover portions 186, 188 are configured to snap together. The inner and outer cover portions 186, 188 could be connected together in a variety of different ways that allow for the selective attachment/detachment thereof, such as, for example, tabs, latches, spring fasteners, etc.

The inner cover portion 186 defines, on the laterally outer surface (i.e., the surface facing the outer cover portion 188), four recesses 187 (only one recess 187 is shown in FIG. 5B). Each recess 187 receives a corresponding one of the busbars 182 therein, which limits relative movement between the busbars 182 and the cover 180. It is contemplated that in other embodiments, the inner cover portion 186 could have other positioners instead of, or in addition to, the recesses 187. For example, in some embodiments, the busbars 182 could be positioned in and/or generally fixed to the inner cover portion 186 via abutting members like latches and/or via an adhesive. It is understood that the inner cover portion 186 defines four recesses 187, one of which is sized and shaped to accommodate for the busbar 182d. Within each recess 187, at each longitudinal end thereof, the inner cover portion 186 defines apertures 202 (only two apertures 202 shown in FIG. 5B). Each aperture 202 is configured to receive a fastener 190 and a metal ring 194 therein.

The inner cover portion 186 has, on the laterally inner surface, casing 200a, 200b, 200c, 200d. The casings 200a, 200b, 200c are similar to one another, and are aligned with corresponding recesses 187, and the casing 200d is disposed at a rear end of the inner cover portion 186. As will be described below, the casings 200a, 200b, 200c, 200d are configured to encase corresponding terminals 134, 154, and insulate the connection between the busbars 182 and the terminals 134, 154 while also assisting in positioning the cover 180 relative to the battery modules 120. Thus, if the cover 180 is removed from the battery modules 120 and the connection unit 122 by moving the cover 180 away therefrom, the busbars 182, 182b, 182c, 182d are disconnected from the terminals 134, 154.

The inner cover portion 186 further has, extending from the laterally inner surface, an interlocker 210, which is part of the retention assembly 127. The interlocker 210 is a protrusion 210, and will henceforth be referred to as such. The protrusion 210 extends generally laterally inward (like the casings 200a, 200b, 200c, 200d). As will be described below, the protrusion 210 of the cover 180 is configured to engage with the right interlocker 152 of the connection unit 122. The cover 170 has a corresponding interlocker 210 configured to engage with the left interlocker 150 of the connection unit 122. It is contemplated that the configurations of the interlockers 150, 210 may vary. For example, the interlocker 150 could be a recess, an aperture or a hook complementary to the interlocker 210. The engagement between the interlockers 150, 210 will be described in greater detail below.

The outer cover portion 188 is sized and shaped to cover the busbars 182 when the outer cover portion 188 is connected to the inner cover portion 186. The outer cover portion 188 defines apertures 189 for receiving the fasteners 190 therein.

The inner and outer cover portions 186, 188 are made of an electrically non-conductive material. In the present embodiment, the inner and outer cover portions 186, 188 are made of plastic, but it is contemplated that another non-conductive material, such as rubber, could be used.

When fully assembled, the busbars 182 are received in the recesses 187 of the inner cover portion 186, and the outer cover portion 188 is connected to the inner cover portion 186 such that the busbars 182 are sandwiched between the inner and outer cover portions 186, 188. The metal rings 194 are received in the apertures 202. The metal rings 194 accommodate for the thickness of the inner cover portion 186 to ensure good connection between the busbars 182 and the terminals 134, 154 when the busbar assembly 126 is connected to the battery modules 120 and to the connection unit 122 (i.e., the metal rings 194 bridge a distance that is present between the busbars 182 and the terminals 134, 154 due to the thickness of the inner cover portion 186).

When the busbar assemblies 124, 126 are connected to the battery modules 120 and the connection unit 122, the busbars 172, 182 are electrically connected to the battery modules 120 and to the connection unit 122, thereby completing the high-voltage battery pack circuit, resulting in high voltage being present between multiple conductors throughout the now completed battery pack circuit. The covers 170, 180, by covering the busbars 172, 182 and by being made of an electrically non-conductive material, assist in limiting the likelihood of coming into contact with conductors which may be at a high voltage. It will be appreciated that due to the configuration of the busbar assemblies 124, 126, when connecting the busbar assemblies 124, 126 to the battery modules 120, the busbars 172 are all electrically connected to respective battery modules 120 at the same time, and the busbars 182 are also electrically connected to respective battery modules 120 at the same time. This limits the likelihood of coming into contact with an exposed conductor energized at a high voltage, while also accelerating and simplifying the connection process between the busbar assemblies 124, 126 and the battery modules 120 and the connection unit 122.

Also, disconnecting the busbars 172, 182 at once ensures that the voltage of any the exposed conductors in the battery pack 100 goes from beyond the pre-determined voltage to below the pre-determined voltage at once, in a single operation, thereby reducing the steps that need to be performed in the presence of exposed high-voltage conductors.

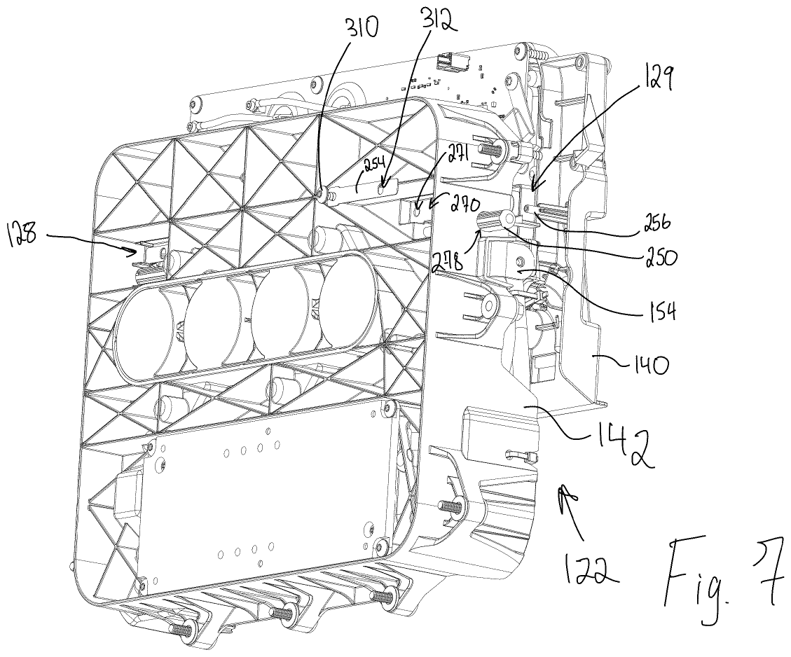

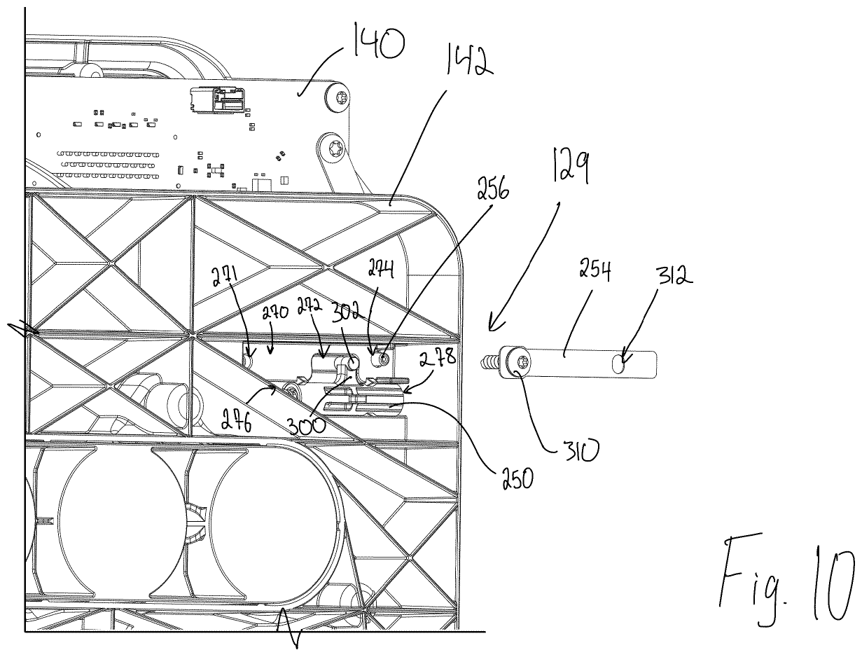

Referring now to FIGS. 7 to 10, the left and right stopping assemblies 128, 129 will be described in greater detail. The left stopping assembly 128 is disposed on a left side of the battery pack 100, and is configured to engage with the left busbar assembly 124. The right stopping assembly 129 is disposed on a right side of the battery pack 100, and is configured to engage with the right busbar assembly 126. Given that the left and right stopping assemblies 128, 129 are similar, only the right stopping assembly 129 will be described in detail herewith.

The stopping assembly 129 includes a stopper 250, a biasing member 252, a locking member 254 and an unlocking member 256. As will be described in greater detail below, in certain situations, the stopper 250 can stop the connection of the busbar assembly 126 to the battery modules 120 and/or to the connection unit 122.

In the present embodiment, the stopping assembly 129 is disposed on the connection unit 122. Part of the stopping assembly 129 is disposed on the connection interface 140 and part of the stopping assembly 129 is disposed on the connection holder 142. More specifically, the unlocking member 256 is disposed on the connection interface 140, whereas the stopper 250, the biasing member 252, and the locking member 254 are disposed on the connection holder 142. It is contemplated that in other embodiments, the stopping assembly 129 could be disposed on any other two adjacent modules, for example, on the battery modules 120b, 120c.

To accommodate for the stopping assembly 129, the connection holder 142 defines on a rear side thereof, a recess 270. Within the recess 270, there is defined a threaded aperture 271, a slot 272 and a through aperture 274. The threaded aperture 271 is positioned laterally opposite the through aperture 274. Vertically below, and adjacent to, the recess 270, there is defined a channel 276. Additionally, the connection holder 142 defines on a right side thereof, a side aperture 278 that is aligned with the channel 276.

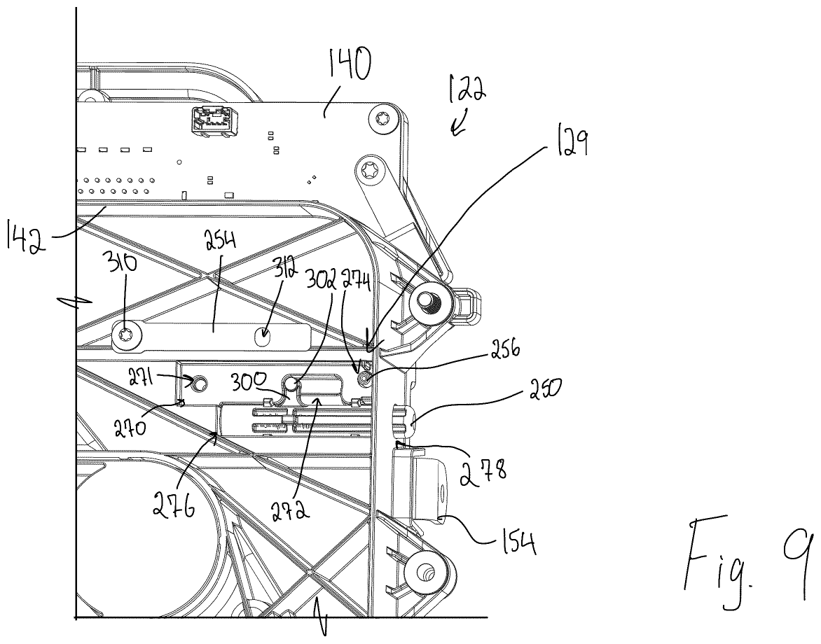

The stopper 250 is received in the channel 276, and extends through the side aperture 278. The stopper 250 has a flange 300 that extends generally vertically upward. The stopper 250, the flange 300, the channel 276 and the slot 272 are configured such that the flange 300 is partially received in the slot 272. The flange 300 has a protrusion 302 that extends generally longitudinally, and as will be described below, the protrusion 302 is configured to engage with the locking member 254. The stopper 250 is moveable between a retracted position, shown in FIG. 9 (stopper 250 of the stopping assembly 128 is also shown in the retracted position in FIG. 3), and an extended position, shown in FIGS. 4, 7, 8A and 10. When the stopper 250 is in the extended position, the stopper 250 extends further outward from the side aperture 278 than when the stopper 250 is in the retracted position. As the stopper 250 slides in the channel 276 between the extended and retracted positions, the protrusion 302 slides in the slot 272.

The biasing member 252 is also received in the channel 276. The biasing member 252 is connected to the connection unit 122 and to the stopper 250. More specifically, one end of the biasing member 252 is connected to a rear wall of the connection holder 142, where the rear wall defines an end of the channel 276. The other end of the biasing member 252 is connected to the stopper 250. The biasing member 252 is a spring, but it is contemplated that in other embodiments, the biasing member 252 could be another resilient member such as a polymeric member. The biasing member 252 biases the stopper 250 toward the extended position.

The locking member 254 is received in the recess 270. The locking member 254 is connected to the connection unit 122 via a fastener 310 that is received in the threaded aperture 271. The locking member 254 is a locking strip that is sized to extend over the through aperture 274. The locking member 254 is at least partially flexible. In the present embodiment, the flexibility of the locking member 254 is in part conferred by the locking member 254 being made of a metallic material. It is contemplated that the locking member 254 could be made of other material such as plastic. The locking member 254 defines an aperture 312 that is configured to, as will be described below, receive the protrusion 302 of the stopper 250 in certain situations.

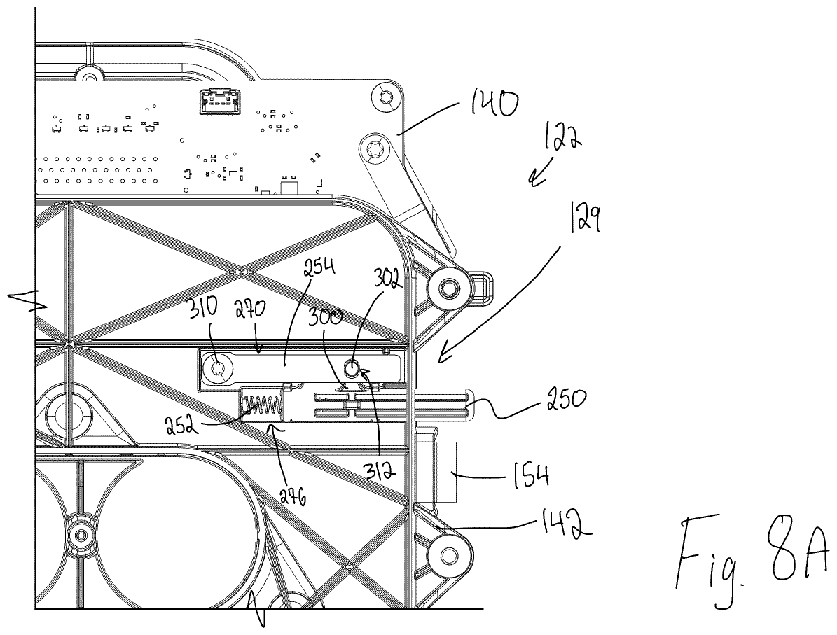

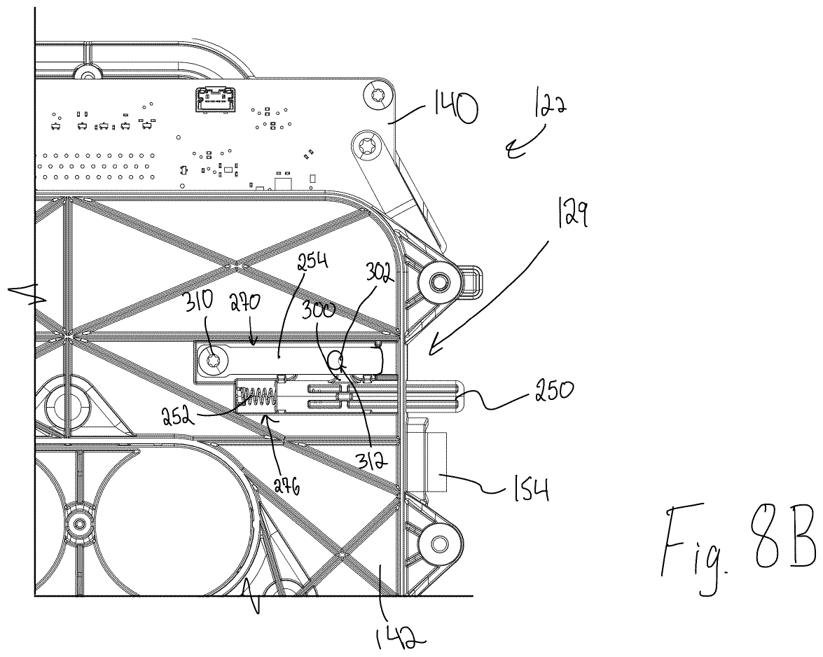

The locking member 254 is moveable between an unlocked position (FIG. 8B) and a locked position (FIG. 8A). In the present embodiment, moving the locking member 254 between the locked and unlocked positions implies deformation, specifically bending, of the locking member 254. However, it is contemplated that the locking member 254 could be configured to pivot or linearly move between locked and unlocked positions.

The unlocking member 256 extends longitudinally rearward from a rear surface of the connection interface 140. The unlocking member 256 is positioned and sized such that when the connection interface 140 is connected to the connection holder 142, the unlocking member 256 partially extends in the through aperture 274, and engages the locking member 254, causing the locking member 254 to move to the unlocked position.

As best seen in FIGS. 4 and 8A, the stopping assembly 129 is configured to prevent connection of the busbar assembly 126 to the battery modules 120 and to the connection unit 122, more specifically, to prevent connection between the busbars 182 and the terminals 134, 154, when the connection interface 140 is spaced from (i.e., not connected to) the connection holder 142.

In more detail, when the busbar assembly 126 is not connected to the connection unit 122 and the battery modules 120a, the stopper 250 is in the extended position due to the biasing member 252. Additionally, when the connection interface 140 is spaced from the connection holder 142, the unlocking member 256 is not received in the through aperture 274, such that the locking member 254 is in the locked position.

When the stopper 250 is in the extended position, and the locking member 254 is in the locked position, the protrusion 302 is received in the aperture 312, which locks the stopper 250 in the extended position (i.e., movement of the stopper 250 is restricted). Thus, if there is an attempt to connect the busbar assembly 126, the stopper 250 abuts against the cover 180, which prevents the cover 180 from reaching a final position in which the busbars 182 are connected to the terminals 134, 154. Thus, mounting of the busbar assembly 126 is not possible when the connection interface 140 is not completely seated on the connection holder 142.

Referring to FIG. 9, the stopping assembly 129 is configured to enable connection of the busbar assembly 126 to the battery modules 120 and the connection unit 122 only when the connection interface 140 is connected to the connection holder 142. Generally, the connection interface 140 would be connected to the connection holder 142 as the final step before connecting the left and right busbar assemblies 124, 126. As a result, the voltage between any two points in the battery pack 100 circuit is configured to only be above the pre-determined voltage after all the battery modules 120 and the connection unit 122 have been connected. This can limit the steps required to assemble the battery pack 100 while high voltage is present.

In more detail, when the connection interface 140 is connected to the connection holder 142, the unlocking member 256 extends through the through aperture 274, and engages the locking member 254. The engagement between the unlocking member 256 and the locking member 254 causes the locking member 254 to bend, thereby moving to the unlocked position. When the locking member 254 is in the unlocked position, the protrusion 302 is no longer received in the aperture 312, such that the stopper 250 is no longer locked in the extended position (i.e., the stopper 250 can move between the retracted and extended positions). Thus, if there is an attempt to connect the busbar assembly 126, after connecting the connection interface 140 to the connection holder 142, the cover 180 abuts against the stopper 250, and causes the stopper 250 to move to the retracted position, and the cover 180 ultimately reaches its final position, in which the busbars 182 are electrically connected to the terminals 134, 154. The busbars 182 can then be fastened to the terminals 134, 154 via the fasteners 190, 192.

Once the busbar assembly 126 is connected to the battery modules 120 and the connection unit 122, the protrusion 210 of the cover 180 is received in the recess 150. The protrusion 210 abuts against the tab 151 of the intermediate portion 155. The interlock between the protrusion 210, the tab 151 and the recess 150 prevents disconnection of the connection unit 122, as well as the connection interface 140 from the battery modules 120 while the busbar assembly 126 is connected to the battery modules 120 and the connection unit 122. Thus, to disassemble the battery pack 100, the busbar assemblies 124, 126 have to first be removed by moving them laterally away from the battery modules 120 and the connection unit 122, which consequently removes the presence of exposed high-voltage conductors on the battery pack, resulting in the battery pack circuit being broken up into multiple low-voltage units.

A description of a method for assembling the battery pack 100 will now be provided.

The method begins by positioning the battery modules 120 in the bottom cover 112. It will be appreciated that at this stage, some of the conductors which, during the course of normal battery pack use, may have a high voltage, are exposed and accessible. However, the busbar assemblies 124, 126 are not, and cannot be, connected to the battery modules 120, such that there is no voltage above the pre-determined voltage present anywhere on the battery pack. The busbar assemblies 124, 126 cannot be connected at this stage, because the connection interface 140 is not connected to the connection holder 142, which results in the stoppers 250 of the stopping assemblies 128, 129 being locked, by respective locking members 254, in the extended position.

The method then continues by connecting the connection holder 142 to the frontmost housing 138 (i.e., the connection holder 142 is connected to the battery module 120a).

The method then continues by connecting the connection interface 140 to the connection holder 142. Connecting the connection interface 140 to the connection holder 142 covers exposed conductors 145 (shown in FIG. 2B) which will eventually be energized at a high voltage. Connecting the connection interface 140 to the connection holder 142 also moves the locking members 254 of the stopping assemblies 128, 129 to their unlocked positions. As described above, each unlocking member 256 of the stopping assemblies 128, 129 moves the respective locking member 254 to the unlocked position, which enables each of the stoppers 250 to move between the retracted and extended positions.

The method then continues by connecting the busbar assemblies 124, 126 to the battery modules 120 and to the connection unit 122. To do so, the busbar assembly 124 is configured to install the busbars 172 on the battery modules 120 and the connection unit 122 together with the cover 170, such that the cover 170 moves the stopper 250 of the stopping assembly 128 to the retracted position and the busbars 172 are electrically connected to respective terminals 134, 154. The busbars 172 are then fastened to respective terminals 134, 154 via the fasteners 190, 192 to secure the connection between the busbars 172 and respective terminals 134, 154. Once connected, the cover 170 fully covers the busbars 172 and the respective terminals 134, 154, which may be energized at a high voltage, making them no longer exposed. Similarly, the busbar assembly 126 is configured to install the busbars 182 on the battery modules 120 and the connection unit 122 together with the cover 180, such that the cover 180 moves the stopper 250 of the stopping assembly 129 to the retracted position and the busbars 182 are electrically connected to respective terminals 134, 154. The busbars 182 are then fastened to respective terminals 134, 154 via the fasteners 190, 192 to secure the connection between the busbars 182 and respective terminals 134, 154. Once connected, the cover 180 fully covers the busbars 182 and the respective terminals 134, 154, which may be energized at a high voltage. It is contemplated that the busbar assembly 126 could be connected to the battery modules 120 and the connection unit 122 before the busbar assembly 124.

At this stage, after connecting the busbar assemblies 124, 126 to the battery modules 120 and the connection unit 122, the voltage between the terminals 154, which are now covered by the covers 170, 180, as well as between other conductors, which are also covered by the covers 170, 180, is above the pre-determined voltage.

The method then continues by fastening the upper cover 114 to the bottom cover 112.

A description of a method for disassembling the battery pack 100 will now be provided.

The method begins by unfastening the upper cover 114 from the bottom cover 112.

At this stage, the battery modules 120 and the connection unit 122 cannot be disconnected from one another, because of the interlock between the interlocks 150, 210. Thus, in order to disconnect the battery modules 120 and/or the connection unit 122 from one another, the busbar assemblies 124, 126 must first be disconnected, which breaks down the single high-voltage battery pack circuit into multiple low-voltage units, removing the presence of a high voltage on conductors which would otherwise be exposed once the connection unit 122 is removed.

The method then continues by unfastening the fasteners 190, 192, and then moving the busbar covers 170, 180 away from the battery modules 120. Due to the connection of the busbars 172 with the cover 170, and due to the connection of the busbars 182 with the cover 180, when the covers 170, 180 are moved away from the battery modules 120, the busbars 172, 182 move away from the battery modules 120 together with the covers 170, 180. Moving the busbars 172, 182 away from the terminals 134, 154 electrically disconnects the battery modules 120 and the connection unit 122 from one another. As a result, the remaining battery pack components are individual low-voltage units, there is no voltage beyond the pre-determined voltage.

It will be appreciated that moving the covers 170, 180 laterally away from the connection unit 122, results in the interlockers 150, 210 being disengaged from one another, such that the connection interface 140 can be disconnected from the connection holder 142, which are below the pre-determined voltage, because the busbars 172, 182 between the modules have been removed, leaving only the low-voltage module circuits. The other battery modules 120 can also be unfastened from one another, and then removed from the bottom cover 112.

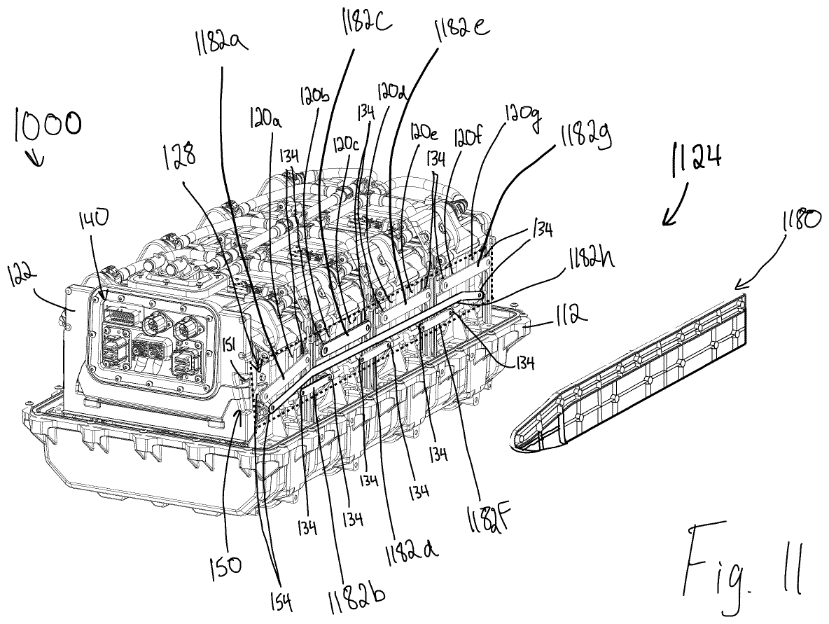

Referring to FIG. 11, a battery pack 1000 according to an alternative embodiment of the present technology is shown. Features of the battery pack 1000 similar to those of the battery pack 100 have been labeled with the same reference numerals, and will not be re-described in detail herewith.

In this embodiment, the terminals 134 of the battery modules 120 and the terminals 154 of the connection unit 122 are all disposed on the same lateral side. In this embodiment, the terminals 134, 154 are disposed on the left side of the battery modules 120 and the connection unit 122. It is contemplated that the terminals 134, 154 could all be disposed on the right side of the battery modules 120 and the connection unit 122.

Additionally, the battery pack 1000, unlike the battery pack 100, only has a single conductor assembly 1124. The conductor assembly 1124 is a busbar assembly 1124. The busbar assembly 1124 includes a cover 1180 (part of which is shown by dotted lines in FIG. 11) and busbars 1182a, 1182b, 1182c, 1182d, 1182e, 1182f, 1182g, 1182h (collectively referred to as busbars 1182). The busbars 1180 are encased in the cover 1180, such that when the cover 1180 is moved away from the battery modules 120, the busbars 1180 move away from the battery modules 120 together with the cover 1180.

The cover 1180 is sized and shaped to entirely cover the busbars 1182 and the terminals 134, 154. The cover 1180 is similar to the covers 170, 180, and will therefore not be re-described herewith.

The busbars 1182 are also similar to the busbars 172, 182 and will therefore also not be re-described in detail herewith.

In this embodiment, installing the busbar assembly 1124 on the battery modules 120 and the connection unit 122 results in the voltage at the output terminals of the battery pack 1000 going from below the pre-determined voltage to above the pre-determined voltage in the single step of installing the busbar assembly 1180 onto the battery pack terminals. The fact that the busbar assembly 1124 is installed in a single step, in which exposed conductors are covered limits the number of steps required to assemble the battery pack 1000 which would otherwise be performed while the battery pack 1000 has exposed conductors energized at a high voltage.

Similarly, removing the busbar assembly 1124 from the battery modules 120 and the connection unit 122 results in the voltage at the output terminals of the battery pack 1000 going from above the pre-determined voltage to below the pre-determined voltage in a single step, which limits steps required to disassemble the battery pack 1000 while the battery pack 1000 presents exposed conductors which are energized at a high voltage.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A battery pack comprising:
at least two low-voltage units;
a first conductor selectively electrically connected to the at least two low-voltage units such that a voltage between two conductors of the battery pack is greater than a pre-determined voltage;
a retention assembly configured to:
with the first conductor electrically connected to the at least two low-voltage units, prevent disconnection of the at least two low-voltage units from each other; and
in response to the first conductor being electrically disconnected from the at least two low-voltage units, stop the first conductor from being electrically connected to the at least two low-voltage units.

2. The battery pack of claim 1, wherein the retention assembly includes a stopping assembly comprising:
a stopper disposed on a first component of the battery pack, the stopper being moveable between a retracted position and an extended position;
a biasing member biasing the stopper toward the extended position;
a locking member disposed on the first component, the locking member being moveable between:
a locked position, in which the locking member is engaged with the stopper; and
an unlocked position, in which the locking member is disengaged from the stopper;
an unlocking member disposed on a second component of the battery pack, the second component being different from the first component, the second component being adjacent to the first component,
the first component is connected to the second component and the first conductor is electrically connected to the at least two low-voltage units such that:
the unlocking member causes the locking member to be in the unlocked position, thereby permitting the stopper to be selectively moved between the retracted position and the extended position; and
the first conductor places the stopper in the retracted position,
in response to the first component being disconnected from the second component and the first conductor being electrically disconnected from the at least two low-voltage units:
the stopper is configured to move to the extended position; and
the locking member is configured to move to the locked position, thereby preventing the stopper from moving toward the retracted position such that the stopper stops the first conductor from being electrically connected to the at least two low-voltage units.

3. The battery pack of claim 2, wherein:
the first component is one of the at least two low-voltage units; and
the second component is an other one of the at least two low-voltage units.

4. The battery pack of claim 2, further comprising a connection unit comprising a connection interface and a connection holder, and wherein:
the first component is one of the connection interface and the connection holder; and
the second component is one of:
an other one of the connection interface and the connection holder.

5. The battery pack of claim 1, further comprising a cover made of non-conductive material connected to the first conductor.

6. The battery pack of claim 5 wherein: the battery pack includes at least one exposed conductor, and with the first conductor electrically connected to the at least two low-voltage units, the cover covers the at least one exposed conductor.

7. The battery pack of claim 5, wherein the retention assembly includes:
a first interlocker disposed on a third component of the battery pack;
a second interlocker disposed on the cover;
with the first conductor electrically connected to the at least two low-voltage units:
the third component is connected to one of the at least two low-voltage units; and
the second interlocker is interlocked with the first interlocker thereby preventing disconnection of the third component from the one of the at least two low-voltage units, and
in response to the first conductor being removed from the at least two low-voltage units, the first interlocker is disengaged from the second interlocker such that the third component is disconnectable from the one of the at least two low-voltage units.

8. The battery pack of claim 7, further comprising a connection unit, and wherein the third component is one of the connection unit and an other one of the at least two low-voltage units.

9. A battery pack comprising:
at least two battery modules, each battery module of the at least two battery modules comprising at least two cells being electrically connected to one another to form a low-voltage circuit;
a connection unit selectively electrically connected to at least one of the at least two battery modules, the connection unit having a connection interface;
a plurality of conductors disposed on at least one of the at least two battery modules and the connection unit;
at least one busbar selectively electrically connected to the at least two battery modules to form a high-voltage circuit between two conductors of the plurality of conductors;
a stopping assembly comprising:
a stopper disposed on a first component of the battery pack, the first component of the battery pack being one of:
the connection unit, or
one of the at least two battery modules,
the stopper moveable between a retracted position and an extended position;
a biasing member biasing the stopper toward the extended position;
a locking member disposed on the first component and being moveable between:
a locked position, in which the locking member is engaged with the stopper; and
an unlocked position, in which the locking member is disengaged from the stopper;
an unlocking member disposed on a second component of the battery pack, the second component of the battery pack being one of:
the connection unit,
the one of the at least two battery modules, and
another one of the at least two battery modules,
the second component being different from the first component,
the second component being adjacent to the first component,
the first component is connected to the second component and the at least one busbar is electrically connected to the at least two battery modules such that:
the unlocking member causes the locking member to be in the unlocked position permitting the stopper to be selectively moved between the retracted position and the extended position; and
the at least one busbar places the stopper in the retracted position,
in response to the first component being disconnected from the second component and the at least one busbar being electrically disconnected from the at least two battery modules:
the stopper is configured to move to the extended position;
the locking member is configured to move to the locked position, thereby preventing the stopper from moving toward the retracted position such that the stopper stops the at least one busbar from being electrically connected to the at least two battery modules.

10. The battery pack of claim 9, wherein the second component is the connection unit, and the first component is one of the at least two battery modules.

11. The battery pack of claim 9, further comprising at least one busbar assembly, the at least one busbar assembly comprising:
the at least one busbar; and
a cover covering the at least one busbar.

12. The battery pack of claim 11, wherein the cover is made of an electrically non-conducting material.

13. The battery pack of claim 9, wherein the at least one busbar is a plurality of busbars electrically connecting the at least two battery modules in series.

14. The battery pack of claim 9, wherein the high-voltage circuit has a voltage greater than 60 volts.

15. The battery pack of claim 9, wherein:
the stopper has a protrusion;
the locking member defines an aperture sized to receive the protrusion; and
with the locking member in the locked position, the protrusion is received in the aperture; and
with the locking member in the unlocked position, the protrusion is out of the aperture.

16. A battery pack comprising:
at least two battery modules, each battery module of the at least two battery modules comprising at least two cells being electrically connected to one another to form a low-voltage circuit;
a connection unit selectively connected to at least one of the at least two battery modules, the connection unit having a connection interface and having a first interlocker;
at least one busbar assembly comprising:
at least one busbar selectively electrically connected to the at least two battery modules to form a high-voltage circuit; and
a cover covering the at least one busbar, the cover having a second interlocker selectively interlocked with the first interlocker,
the at least one busbar being electrically connected to the at least two battery modules such that:
the second interlocker is interlocked with the first interlocker thereby preventing disconnection of the connection unit from the at least two battery modules; and
in response to the at least one busbar assembly being removed from the connection unit and the at least two battery modules, the first interlocker being disengaged from the second interlocker such that the connection unit is disconnectable from the at least two battery modules.

17. The battery pack of claim 16, wherein the at least one busbar is connected to the cover such that in response to the at least one busbar assembly being removed from the connection unit and the at least two battery modules, the at least one busbar assembly is configured to remove the at least one busbar together with the cover.

18. The battery pack of claim 16, wherein the first interlocker is a recess, and the second interlocker is a protrusion configured to be received in the recess.

19. The battery pack of claim 16, wherein the cover is made of an electrically non-conducting material.

20. The battery pack of claim 16, wherein the high-voltage circuit has a voltage greater than 60 volts.
